(19) United States
(12) Patent Application Publication
(10) Pub. No.: US 2011/0119383 A1
(43) Pub. Date: May 19, 2011

(54) AGGRESSIVE RESOURCE MANAGEMENT

(75) Inventors: Bernardus Adrianus Cornelis Van Vlimmeren, Veldhoven (NL); Jack Alexander Goossen, Eindhoven (NL)

(73) Assignee: NXP B.V., Eindhoven (NL)

(21) Appl. No.: 12/936,915

(22) PCT Filed: Apr. 9, 2009
(86) PCT No.: PCT/IB2009/051513

§ 371 Date: Feb. 2, 2011

(30) Foreign Application Priority Data
Apr. 9, 2008 (EP) 08103450.6

(51) Int. Cl. G06F 15/173

(52) U.S. Cl. 709/226

(57) ABSTRACT

The present application relates to a method, system and a computer readable medium. The method comprises processing an application which uses at least one resource, wherein at least one proxy is generated depending on the application, wherein at least two substantially similar resources are claimed by the proxy, and wherein the actually used resource for processing the application is determined depending on at least one predefined criterion.

### TECHNICAL FIELD

The present application relates in general to a method for processing an application which uses at least one resource, wherein resources are located on different subsystems. The present application relates also to a system comprising subsystems connectable with each other and a computer readable medium having a computer program stored thereon.

### BACKGROUND OF THE INVENTION

Modern media systems, like high-end mobile phones, car infotainment systems or the like, comprise multiple subsystems. In the case of a high-end mobile phone, an audio subsystem, a modem subsystem, a Bluetooth subsystem and the like may exist. Most of new developed media systems may comprise some new developed subsystems for implementing new features and established subsystems as well. Thus, different subsystems may comprise generally varying resources as well as at least similar resources.

This implies that overlaps of capabilities between several subsystems within a distributed system may exist. Referring to the above-mentioned example of a high-end mobile phone and the respective subsystems, each of these subsystems may comprise resources for decoding data formats, like certain audio data formats.

The same applies for software components of modern media systems. New high-end embedded systems may comprise new software components and may also reuse already existing software components. An overlap between resources may also exist in this case.

However, issues may occur by combining existing subsystems with new developed or already existing subsystems. In several applications, it may be possible that a certain function can be performed by many subsystems. Then, a problem may arise since it may not be apparent onto which subsystem the application may be mapped. Several cases may cause a benefit by using a resource of one subsystem or of another subsystem. However, in prior art suitable methods for improving of processing an application by determining suitable resources are not known.

It is one object of the present application to provide an improved aggressive resource management. A further object is to avoid the necessity of an intervention of an application programmer. A further object is to reduce power consumption. Another object is to minimize bandwidth between subsystems.

### SUMMARY OF THE INVENTION

These and other objects are solved by a method comprising processing an application which uses at least one resource, wherein at least one proxy is generated depending on the application, wherein at least two substantially similar resources are claimed by the proxy, and wherein the actually used resource for processing the application is determined depending on at least one predefined criterion.

The method according to the present application can be used in several systems, in particular in media systems. Such a system may comprise several subsystems. A media system may be designed to perform different applications, like decoding audio data, decoding video data, coding these data or the like.

In general, an application can be processed by using at least one resource. Moreover, at least one proxy is generated depending on the application. For an application several proxies may be generated which may define the application. For each possible application which may be processed, respective proxies may be already recorded within the system. However, according to other variants of the present application, proxies may be newly generated for each application, for instance, depending on stored algorithms.

The at least one proxy claims at least two substantially similar resources which are available. The resources may be equivalent, identical or same resources. Furthermore, more than only two substantially similar resources can be claimed by one or more proxies. In a distributed system, the claimed resources which are required to process the application defined by the proxy may be located on different subsystems. Furthermore, the at least substantially similar resources may be provided by more than one subsystem. In case, at least two subsystems may provide two substantially similar resources, the actually used resource has to be determined.

It is found, according to the present application that an improved solution for determining the actually used resource may be achieved by determining the respective resource depending on at least one predefined criterion. Such a criterion may be defined depending on system requirements or the like. It may be possible to define the at least one criterion during development and/or initializing of the system. At least depending on one criterion, the actually used resource of at least two claimed resources which may be located on distributed subsystems can be determined. In particular, the unnecessary resource/s can be released. It may be advantageously to delay releasing unnecessary resource/s at least until processing the application is activated.

The present method provides for an improved processing of an application. An intervention of an application programmer can be avoided. The effort of implementation and performing the method according to the present application may be low.

According to a further embodiment of the present application, all available resources may be claimed. For instance, all available resources can be claimed which can be employed in a useful way. By claiming all available resources, all possibilities for performing the application are given. The choice of the actual resource can be taken depending on at least one predefined criterion. One or more resources may be released during selection of the respective most suitable resource. Processing the application can be improved.

According to an embodiment of the present application, a request for an application may be received. When a request of the application is received, at least one proxy defining the received application may be generated. The proxy may be created immediately after receiving a request for the application.

In another embodiment, at least one resource may be formed as at least one filter unit. Such a filter unit can be a processing step or functionality. More than one filter unit can be arranged which may form a filter graph. In general, a filter graph may comprise filter units which can be connected via edges. Meanwhile, the edges or connections may represent one way data flow between two filter units, the filter units may represent processing steps. Each required processing step for performing an application can be expressed at least by one respective filter unit. A filter graph and the filter units respectively are especially suitable to express a resource, in particular within a media system. It should be understood that according to further variants of the present application, other representations of resources are also possible.

Furthermore, according to an embodiment, generating the at least one proxy may comprise generating at least one proxy filter unit. One proxy filter unit may represent at least one processing step which may be performed on another location. In case more than one proxy filter unit is generated the proxy filter units may be connectable with each other. Two connected proxy filter units may be a proxy filter graph. A proxy filter graph can be used advantageously to define an application. The created proxy filter graph and proxy filter units respectively may only represent processing steps being performed on distributed subsystems in contrast to the filter units mentioned above. It may be advantageously to connect proxy filter units in a correct order according to a further embodiment. The connected proxy filter units may represent a process sequence schedule for processing the application. The correct order may depend on required processing steps which have to be performed successively. According to other variants of the present application, the proxy may also be implemented by other representation options.

Furthermore, the determined resources may be connected according to a further embodiment of the application. Generally, for processing an application, several resources may be required which can be connected in a suitable order. The order can be defined by the proxy, for example by the order of the arranged proxy filter units. The connected resources may represent the actually performed process sequence. A connection between filter units may also provide data exchange between them. Additionally, the first used resource can be connected with an input data stream meanwhile the last used resource can be connected to an output interface or the like. For the special case, only one resource is required for processing an application, this resource may be connected to both, an input and output interface or the like. Connecting the determined resources may depend on the choice of the actually used resources. Until the application may be activated, connecting and selecting can be performed depending on at least one predefined criterion.

It is further found, according to the present application that connecting the selected resources may be controlled by the created proxy. By use of appropriate means, the proxy may control connecting resources and supplying the resources with the respective data flow. In particular, the data flow between resources located on different subsystems can be controlled by the proxy. More particularly, according to a further embodiment, the filter units may be connected with each other. Furthermore, controlling of connecting the filter units and the data flow between them can be performed by the created proxy filter units. In particular, proxy filter units may be in charge of marshalling the necessary control and data to the actual filter units and subsystems respectively. This concept allows that filter units of different subsystems can easily be employed without the intervention of an application programmer.

In another embodiment according to the present application, the actually determined resources and/or order of the connected resources may be stored. Storing this information, in particular storing which resources has been actually used and which resource is connected to at least another resource can be performed. Suitable means for storing can be arranged. Furthermore, information about processing parameters, like calculation time, power consumption and the like can be stored and, for instance, can be analyzed by suitable means.

According to a further embodiment, the stored information can be used as a predefined criterion. By way of example, in case, a request for an application is received, wherein the application may be at least similar to an already processed application, the stored information corresponding to the already processed application can be used to create the same actual process sequence again or to create another actual process sequence. In particular, the same resources can be used as well as they can be connected in similar order. This may depend upon whether the previous performed application was processed successfully or in an at least sufficient optimized manner. Other dependencies are possible as well. For instance, the analyzed information of a processed application can be used for determining the actually used resource. A constant high quality can be provided for processing an application.

As a predefined criterion, system parameters can be used according to an embodiment of the present application. For instance, system utilization can be employed as a predefined criterion. Furthermore, according to an embodiment, predefined criteria may be also power consumption criterion and/or bandwidth criterion and/or localization criterion and/or defensive criterion.

For instance, one predefined criterion may be the power consumption or battery status of a distributed system, like a media system. In many devices, such as mobile phones or similar high embedded systems, it is a continuous concern to reduce power consumption due to limited reservoir of energy. For example, in case of a high level of the battery status, it may be advantageously to select a resource located on a first subsystem. The same resource located on another subsystem can be preferred in case of a low battery status. In general, the resource which may dissipate less power can be determined. Information about power consumption of resources may be stored within the storing means. After processing the application and analyzing of the process, the information can be updated. Power consumption can be significantly reduced.

Furthermore, a bandwidth criterion can also be used as the predefined criterion for determining the actual resource. For the case, resources may be located on different subsystems, a communication among them may require a certain bandwidth. It may be desirable to minimize the essential bandwidth between subsystems. Thus, the subsystems encompassing the needed resources may be connected to each other in a suitable order which requires minimum bandwidth. Also this information may be stored within the storing means.

Additionally, the localization of the claimed resources may be a criterion as well. It may be advantageously to employ resources of merely one subsystem or at least of a minimum number of essential subsystems. Controlling can be significantly eased.

It is also possible to optimize the actually used process sequence depending on defence criteria. Some or at least one subsystem may be avoided in general or merely for a special application. Such a criterion may depend on system requirements as well as it may depend on user wishes.

All mentioned criteria can be used for determining the actually used resources and performing the respective application. Furthermore, other aspects corresponding to the system can be improved, like power consumption or the like. During development of a system, its initialization or its use, the criteria can be defined and also improved. By way of example, processed applications can be analyzed and criteria can be adjusted according to achieved results. Suitable means for analyzing, such as digital processors or the like can be implemented. Thus, the system can also be optimized during its use. In particular, for the case such a system is updated, the use of new implemented functions can easily be integrated within the system and their use can be optimized using the method according to the present application.

It should be understood that, according to other variants of the present application, merely one criterion, any combinations of criteria or all criteria can be used for optimizing. In case, more than one criterion is used, the criteria may comprise different priorities. Moreover, further criteria according to system requirements, calculating times or user wishes may also be used.

In another embodiment, an interface which may be provided by arranged subsystems may be discovered. For easily communicating, the subsystems may provide a same interface, in particular a standard interface. For instance, OpenMAX IL may be employed as an interface according to an embodiment of the present application. Discovering the interface of the subsystems, especially of all arranged subsystems provides for the ability to connect the actual run filter units in a suitable order and transferring the required data. The method according to the present application can be easily implemented.

Another aspect of the present application is a system comprising a host subsystem. The system encompasses a first subsystem comprising at least one resource. The system includes at least a further subsystem comprising at least one resource, wherein the host subsystem comprises generating means configured to create at least one proxy depending on an application. The proxy is configured to claim at least two substantially similar resources, wherein at least one resource is located on the first subsystem. The host subsystem comprises determining means configured to determine the actually used resource depending on at least one predefined criterion.

It should be understood that in case, the host subsystem comprises also at least one resource, host subsystem and first subsystem may be provided as one single subsystem.

According to another embodiment of the present application, the host subsystem may comprise a service broker unit. The service broker unit may communicate the data stream to the further subsystem, on which a filter unit may run. It may be possible that the service broker unit may collaborate with the interface. Moreover, the service broker unit may also be configured to discover resources located on distributed subsystems and to claim these resources. The service broker unit may be driven by the created proxy and proxy filter units respectively. Controlling the actually used resources can be performed in an easy manner.

What is more, the first subsystem and the further subsystem may comprise a service provider unit. A service provider unit may allow a host subsystem to discover the available resources of the respective subsystem. In addition, service provider units may be configured such that the host subsystem is able to claim some or all resources necessary for processing the application.

Another aspect of the present application is a computer readable medium having a computer program stored thereon. The computer program comprises instructions operable to cause a processor to perform the above-mentioned method.

The method, system and computer program stored on a computer readable medium according to the present application can be employed within any media system, like high-end mobile phones, car infotainment systems or the like. In particular, the present method and system can be used in every system comprising overlapping functionalities or the like.

These and other aspects of the present patent application become apparent from and will be elucidated with reference to the following Figures. The features of the present application and of its exemplary embodiments as presented above are understood to be disclosed also in all possible combinations with each other.

### BRIEF DESCRIPTION OF THE DRAWINGS

In the Figures show:

FIG. 1 an embodiment of a system according to the present application;

FIG. 2 a further embodiment of a system according to the present application;

FIG. 3 an exemplified flowchart of the method according to the present application.

Like reference numerals in different Figures indicate like elements.

### DETAILED DESCRIPTION OF THE DRAWINGS

In the following detailed description of the present application, exemplary embodiments of the present application will describe and point out that processing an application within a distributed system can be easily improved using predefined criteria without involving an application programmer.

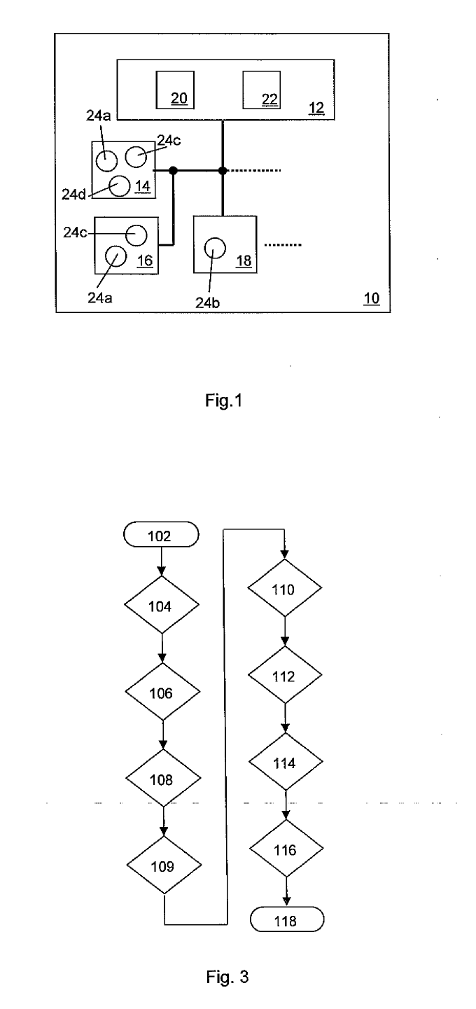

FIG. 1 shows a simplified embodiment according to the present application. A system 10 comprises a host subsystem 12 and further subsystems 14 to 18. It shall be understood that, according to other variants of the present application, less or more subsystems can be arranged within the system 10. System 10 may be any media system, like a mobile phone or the like. The depicted subsystems 12 to 18 can be connected with each other. In particular, the host subsystem 12 can be connected to each arranged subsystem 14 to 18.

Furthermore, each of the subsystems 14 to 18 may include resources 24a to 24d. Such a resource 24a to 24d may be a particular functionality or processing step. According to the shown system 10, each subsystem 14 to 18 may provide one or more resources 24a to 24d. According to other variants of the present application, it is also possible that a resource 24a to 24b may be not provided by a subsystem 14 to 18. In this embodiment, subsystem 14 may comprise resources 24a, 24c, 24d meanwhile subsystem 18 may comprise resource 24b. It can be seen from FIG. 1 that some similar resources 24a to 24d may be provided by several subsystems 14 to 18. For instance, resources 24a and 24c are provided by both subsystem 14 and subsystem 16. Moreover, by way of example, resource 24a located on subsystem 14 and resource 24a located on subsystem 16 may be equivalent, identical or same resources 24a. In contrary, resource 24b may only be provided by subsystem 18. According to the present embodiment, the resources 24a to 24d may be employed to process a certain application. It should be understood that each subsystem 14 to 18 may also comprise further resources according to other variants of the present application.

The host subsystem 12 may encompass at least generating means 20 and determining means 22. The generating means 20 may be configured to create at least one proxy, in particular several proxy filter units. The at least one proxy may claim all available resources 24a to 24d which may be located on the different subsystems 14 to 18. As soon as a request for an application may be received by the host subsystem 12, the generating means 20 may start to create the proxy, for example a proxy filter graph defining a process sequence schedule for processing the application.

Additionally, the determining means 22 may be configured to determine the actually used resources 24a to 24d depending on at least one predefined criterion after starting to create the proxy. It is advantageously to wait as long as possible before determining the actually used resource 24a to 24d. The most suitable solution can be achieved and thus, processing the application can be significantly improved.

In the following, the functioning of system 10 shown in FIG. 1 will be elucidated by the aid of FIG. 3. FIG. 3 shows an exemplified flowchart of the method according to an embodiment of the present application. After the method is started in step 102, a request for a certain application may be receipt in step 104. More particularly, a host subsystem 12 of a system 10 may receive the request. For instance, an application may be decoding a certain audio format, decoding certain video format or the like.

In a next step 106, the host subsystem 12 may discover the interfaces provided by the further arranged subsystems 14 to 18. In particular, the host subsystem 12 may discover a certain standard interface, such as OpenMAX IL. However, other interfaces can be used as well. For lucidity reasons, an interface is not shown in the present Figures. An advantage of such a standard interface is that the respective subsystems 12 to 18 may communicate with each other in an easy manner. It should be understood that discovering an interface of the subsystems 12 to 18 (step 106) may also be performed uniquely at the initialization of the system 10. In this case, calculating time can be saved.

Generally, processing an application can be divided in several steps, in particular processing steps. Each processing step may be performed by at least one resource 24a to 24d which may be located on subsystems 14 to 18. In particular, an application can be processed by use of resources 24a to 24d in a suitable order. The order may represent the process sequence of an application. As can be seen from FIG. 1, several resources 24a to 24d, like resource 24a, may be provided by more than one subsystem 14 to 18. Thus, the respective most suitable resource 24a to 24d according to at least one predefined criterion should be determined.

For processing the application in an improved way, in a following step 108, the host subsystem 12 may start to create the at least one proxy. One example of such a proxy may be at least one proxy filter unit. More particularly, several proxy filter units may be created. Each of these proxy filter units may represent at least one particular resource 24a to 24d and processing step respectively. It may be advantageously to connect the proxy filter units in a correct order, like a process sequence schedule. The proxy may claim all available resources 24a to 24d (step 109). As already mentioned, the host subsystem 12 may comprise generating means 20 for performing step 108. All available servers can be instantiated.

As a next step 110, after starting to create the proxy (108), it can be started to create the actually process sequence. More particularly, in step 112, the actually used resources 24a to 24d can be determined for the case at least two substantially similar resources 24a to 24d are claimed by the proxy (step 109). A resource 24a to 24d may be formed by a filter unit or a filter graph comprising at least two filter units. The decision which resource 24a to 24d of which subsystem 14 to 18 will be actually used for processing the application can be delayed as long as possible. Thus, various properties can be optimized without the need of involving an application programmer. The resources 24a to 24d being actually used may be determined depending on at least one predefined criterion by determining means 22 to achieve an optimal or at least improved solution. Several criteria which may comprise different priorities may be used to find the optimal solution for processing the application. One possibility for determining the actually used resources 24a to 24d may depend on information of prior processed applications. Information of prior processed applications may be stored in suitable storing units. For determining the actually used process sequence, in particular, the actual resource 24a to 24d and the connection between the determined resources 24a to 24d, it can be accessed to the required information.

Furthermore, by way of example, the battery status of the system 10 can be checked. Depending on the battery status, the resource 24a to 24d of a subsystem 14 to 18 can be chosen which is most suitable. For instance, energy consumption can be reduced due to the selection of the more economical resource 24a to 24d. Information can be accessed from the storing unit. Another possibility to optimize the actual process sequence may comprise the aim to minimize bandwidth between the involved subsystems 12 to 18. Since bandwidth information may be known by the host subsystem 12, subsystems 12 to 18 can be connected to another which may require less bandwidth. Furthermore, the choice of the actually used resources 24a to 24d and filter units respectively may also depend on their respective localization. For instance, a single subsystem 14 to 18 or at least as little subsystems 14 to 18 as possible may be employed for performing the processing steps, if it is possible. By way of example, according to FIG. 1, merely resources 24a to 24d located on subsystem 14 and 18 may be used instead of using additionally subsystem 16. It can also be advantageously to avoid certain subsystems 14 to 18 for a special application or generally depending on predefined adjustments.

Additionally, the mentioned criteria can be combined to each other to obtain an improved solution with respect to different criteria. For avoiding inconsistencies during determining a resource 24a to 24d, the mentioned criteria may comprise different priorities. For instance, determining the respective resource 24a to 24d may depend on the battery status and a localization criterion wherein the battery status may encompass a higher priority. For example, resource 24a of subsystem 16 should be used due to the power consumption criterion meanwhile resource 24 of subsystem 14 should be used due to the localization criterion. The decision among them may occur depending on the higher priority of one of the mentioned criteria. The priorities corresponding to different criteria can be set according to system requirements, user wishes or the like.

It should be understood that according to further embodiments of the present application, other criteria can be used for optimizing the actual process sequence as well.

In the following step 114, the actually determined resources 24a to 24d may be connected with each other and to an input data stream and an output unit in a suitable order. In other words, the actual process sequence can be activated. Controlling the correct connection and the supply of data to the used resources 24a to 24d may be performed by the proxy, like the proxy filter units of a proxy filter graph. After connecting at least two or all determined resources 24a to 24d with each other, this information can be stored in step 116.

In particular, the actually used resources 24a to 24d for a particular application may be stored. The stored information can be analyzed according to several criteria and used again in case, the host subsystem 12 receives a request for a same or a similar application. Appropriate storing and analyzing units may be employed within system 10. The method according to the present embodiment can be terminated after processing the application in the last step 118.

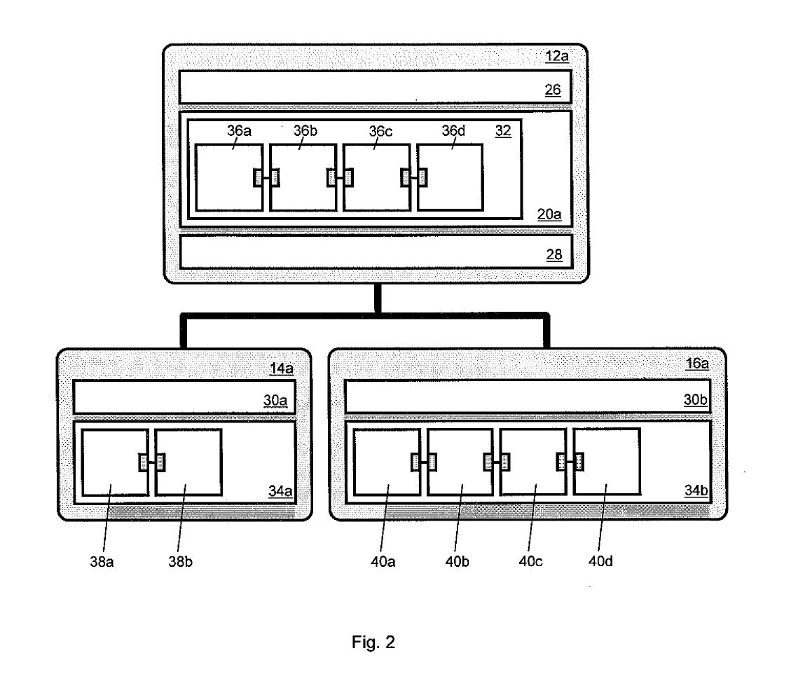

In FIG. 2, a further embodiment of a system according to the present application is illustrated. The shown exemplified system comprises a host subsystem 12a and two further subsystems 14a, 16a. According to the present embodiment, a storage subsystem 14a and an audio subsystem 16a are depicted. For lucidity reasons, merely three subsystems 12a, 14a, 16a of a media system are shown. As can be seen from FIG. 3, both subsystems 14a, 16a are able to communicate at least with the host subsystem 12a. Provided that the host subsystem 12a has already discovered a suitable standard interface, like OpenMAX IL, data can easily be exchanged between the host subsystem 12a and the two further subsystems 14a, 16a.

As can be seen from FIG. 2, the host subsystem 12a comprises an application 26 Totem. According to the present embodiment, video decoding should be performed by the system. This can be expressed by a filter graph 32 which can also be called streaming graph 32, created by the generating means 20a.

For exchanging data, the host subsystem 12a provides a service broker unit 28, meanwhile the storing subsystem 14a as well as the audio subsystems 16a comprises a service provider unit 30a, 30b. The service broker unit 28 may be configured to discover resources provided by subsystems 14a, 16a, in particular by the arranged service provider units 30a, 30b. Moreover, the service broker unit 28 is driven by the proxy and can be used for claiming resources located on the subsystems 12a, 14a.

What is more, the storage subsystem 14a and the audio subsystem 16a may comprise a filter graph 34a, 34b. The depicted embodiment shows merely the processing steps relevant for the present application. According to the present application, a filter graph 34a, 34b may comprise filter units 38a to 40d relevant for the present application. It can be assumed that determination of actually used resources has been already performed. By way of example, filter graph 32a may include two filter units 38a, 38b. For instance, a file source unit 38a and a tcp sink unit 38b may be arranged. Purpose of this filter graph 34a may be the conversion of a particular source data format to a tcp data format for further processing.

The other filter graph 34b located on the audio subsystem 16a may comprise four filter units 40a to 40d, like tcp source unit 40a, MP3 decoder unit 40b, volume unit 40c and audio sink unit 40d. However, according to other embodiments of the present application, each of the subsystems 14a, 16a may comprise further resources or functionalities. In particular, the subsystems 14a, 16a may encompass also at least two similar filter units.

Referring to the received request for the application, the host subsystem 12a may create a corresponding proxy filter graph 32, wherein all available filter units 38a to 40d located on subsystems 14a, 16a are claimed by the proxy. The proxy filter graph 32 can be expressed by a so called play bin. A play bin may comprise proxy filter units 36a to 36d. Each of the proxy filter units 36a to 36d may represent a particular processing steps which can be performed by one or more actual filter units 38a to 40d located on a further subsystem 14a, 16a. In the present example, a file source proxy filter unit 36a, a MP3 decoder proxy filter unit 36b, a volume proxy filter unit 36c and finally an audio sink proxy filter unit 36d are provided. The provided proxy filter units 36a to 36d can be arranged and connected in a correct order with respect to required consecutive processing steps. For instance, firstly a source data format must be converted to a tcp data format for further processing according to the present embodiment.

The proxy filter units 36a to 36d may be configured to control the data flow between the actual filter units 38a to 40d. More particularly, the proxy filter units 36a to 36d may provide for a connection of the actual filter units 38a to 40d in a correct order and to control the data flow between them. The host subsystem 12a may receive source data which can be fed to the first actually used filter unit controlled by the file source proxy filter units 36a. In this embodiment, the data may be forwarded to the file source unit 38a. The further filter units 38b to 40d may be connected in a correct order which may depend on the created proxy and the data flow between them may be controlled by the further proxy filter unit 36b to 36d. In particular, the tcp sink 38b located on the storage subsystem 14a may be connected to tcp source 40a of audio subsystem 16a controlled by the respective proxy filter unit. Finally, the desired audio format can be achieved after passing the filter units 38a to 40d in a correct order.

Furthermore, it is readily clear for a person skilled in the art that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. The computer software may be stored in a variety of storage media of electric, magnetic, electro-magnetic or optic type and may be read and executed by a processor, such as for instance a microprocessor. To this end, the processor and the storage medium may be coupled to interchange information, or the storage medium may be included in the processor.

1. A method, comprising:
processing an application which uses at least one resource,
wherein at least one proxy is generated depending on the application,
wherein at least two substantially similar resources are claimed by the proxy, and
wherein the actually used resource for processing the application is determined depending on at least one predefined criterion.

2. The method according to claim 1, wherein all available resources are claimed.

3. The method according to claim 1, wherein processing the application comprises receiving a request for the application.

4. The method according to claim 1, wherein at least one resource is formed as at least one filter unit.

5. The method according to claim 1, wherein generating the proxy comprises generating at least one proxy filter unit.

6. The method according to claim 5, wherein at least two proxy filter units are present, and the proxy filter units are connectable with each other.

7. The method according to claim 6, wherein the proxy filter units are connected in correct order.

8. The method according to claim 1, further comprising connecting the selected resources with each other.

9. The method according to claim 8, wherein connecting the selected resources is controlled by the created proxy.

10. The method according to claim 5, further comprising connecting the filter units with each other.

11. The method according to claim 6, wherein connecting the filter units is controlled by the respective proxy filter unit.

12. The method according to claim 10, further comprising storing at least one of:
the actually selected resources, and
an order of the connected resources.

13. The method according to claim 12, wherein the at least one predefined criterion depends on the stored information.

14. The method according to claim 1, wherein the at least one predefined criterion is a system parameter.

15. The method according to claim 1, wherein the at least one predefined criterion is at least one of:
a power consumption criterion,
a bandwidth criterion,
a localization criterion, and
a defensive criterion.

16. The method according to claim 1, further comprising discovering an interface provided by arranged subsystems.

17. A system, comprising:
a host subsystem,
a first subsystem comprising at least one resource,
at least a further subsystem comprising at least one resource,
wherein the host subsystem comprises generating means,
configured to create at least one proxy depending on an application,
wherein the proxy is configured to claim at least two substantially similar resources,
wherein at least one resource is located on the first subsystem, and
wherein the host subsystem comprises determining means configured to determine the actually used resource depending on at least one predefined criterion.

18. The system according to claim 17, wherein the host subsystem comprises a service broker unit.

19. The system according to claim 17, wherein at least the first subsystem comprises a service provider unit.

20. The system according to claim 17, wherein each of the subsystems comprises a standard interface.

21. The system according to claim 20, wherein the standard interface is OpenMAX IL.

22. A media system comprising a system according to claim 17.

23. A computer readable medium having a computer program stored thereon, the computer program comprising instructions operable to cause a processor to perform a method according to claim 1.
